(19) United States
(12) Patent Application Publication
(10) Pub. No.: US 2026/0139719 A1
(43) Pub. Date: May 21, 2026

(54) LOW-FREQUENCY TUNED MASS DAMPING DEVICE WITH REVERSE-STRETCHED COMPRESSION SPRINGS

(71) Applicant: DALIAN UNIVERSITY OF TECHNOLOGY, Dalian (CN)

(72) Inventors: Fuyou XU, Dalian (CN); Xinyu CAI, Dalian (CN); Yutong ZENG, Dalian (CN); Mingjie ZHANG, Dalian, Liaoning (CN); Zhanbiao ZHANG, Dalian (CN)

(21) Appl. No.: 19/402,652

(22) Filed: Nov. 26, 2025

(30) Foreign Application Priority Data
Oct. 11, 2025 (CN) 202511445823.X

(51) Int. Cl. F16F 7/104; E01D 19/00

(52) U.S. Cl. CPC F16F 7/104; E01D 19/00

(57) ABSTRACT

The present invention belongs to the technical field of low-frequency vibration control, provides a low-frequency tuned mass damping device with reverse-stretched compression springs. The device fully realizes large compression deformation and reverse stretching deformation of the springs within a limited vertical space by performing supercompression-reverse stretching treatment on the compression springs, achieving lower stiffness required by the vibrating system, and can realize low-frequency tuning within the limited vertical space of the main beam of the bridge, greatly expanding the frequency application range of the tuned mass device. Meanwhile, the device avoids the stability problem faced by the traditional compression spring tuned mass placed on the springs and the problem of excessive damping and instability caused by the increase of guiding members as a result. The device can be applied to the control of various types of low-frequency vibration in vertical, lateral and torsional directions of various engineering structures.

### TECHNICAL FIELD

The present invention belongs to the technical field of low-frequency vibration control, and relates to a low-frequency tuned mass damping device with reverse-stretched compression springs.

### BACKGROUND

Under the action of wind loads, the main span of kilometer-scale long-span bridges may experience vertical or torsional vortex-induced vibration (VIV for short) with frequencies lower than 0.2 Hz, affecting driving comfort and even safety. For example, the vortex vibration frequencies of the Xihoumen Bridge in Zhejiang Province and Humen Bridge in Guangdong Province are as low as 0.1 Hz and 0.17 Hz respectively. The traditional tuned mass damper, if installed in a main beam with a vertical space of 3 m, can be used for high-frequency (e.g. >0.3 Hz) vortex vibration control of a bridge. The tuned mass damper spring is generally in two forms: tension or compression, and the deformation l thereof under the action of the tuned mass and the vibration frequency f roughly satisfy the relationship of l=g/(2πf)\hat{ }2. The tension spring is flexible in installation and is stable in structure. However, for a main beam with a vertical installation space of only 3-4 m, excluding the original length of the spring, the thickness of the tuned mass and the vibration space, the space left for the spring to stretch and deform is at most 2-3 m, and the applicable frequency is basically not less than 0.3 Hz. The compression spring has compact structure and larger deformation than the tension spring. For a main beam with a vertical installation space of 3-4 m, although the compression deformation of the spring can reach 6 m or even 8 m, and theoretically, the spring can be applicable to vortex vibration control with a frequency of 0.15 Hz, but is difficult to install and faces a problem of pressure stability. Therefore, lateral stability measures need to be added. This will lead to a complex structure and inevitably introduce frictional damping that is difficult to precisely control due to the guiding device, seriously affecting the effect of vibration control. To achieve lower vibration frequency tuning, an inerter element can be introduced to reduce the static deformation of the spring (i.e., the tuned mass inerter damper), but the control efficiency thereof drops significantly, and the control effect thereof is more sensitive to multiple parameters such as a frequency ratio and a damping ratio, and some deficiencies still exist in terms of economy and applicability, so it is difficult to be applied in practical engineering.

### SUMMARY

In view of the technical limitations of traditional tuned mass dampers and tuned mass inerter dampers in the field of low-frequency vibration control, the present invention aims to provide a brand-new concept to achieve a tuned mass system with a frequency as low as 0.1 Hz within a 3-4 m vertical space of a main beam of a long-span bridge by supporting the tuned mass with springs. With a compression spring having an original length of about 25 m as an example, the bottom coil of the spring is fixed, and the spring is gradually compressed from the top coil. Each coil of the spring can be reversely stretched from the middle hole or the outer edge of the spring. Finally, the original coil of the spring can be lower than the lowermost coil. At this point, the compression spring has transformed into a reverse stretching spring, and the actual deformation thereof has exceeded 25 m. Hanging an appropriate mass block can ensure that the spring is basically in a tension state and has a frequency as low as 0.1 Hz.

The technical solution of the present invention is as follows:

A low-frequency tuned mass damping device with reverse-stretched compression springs, comprising helical compression springs, a tuned mass and a damping element;

The helical compression springs are placed vertically, horizontally or obliquely, the bottom coils are fixed on circular rings having corresponding sizes, pressure is continuously applied to the helical compression springs at the top coils or intermediate local positions of the helical compression springs until the top coils of the helical compression springs pass through or fit over the bottom coils and flip over, and the helical compression springs are fixed in the flipped state; the bottom coils of the helical compression springs in the flipped states are installed on a top plate of a box girder or at the top of a built-in support of the box girder, and the helical compression springs at this time are reverse helical compression springs; the top coils of the helical compression springs are located at lowermost expansion ends and are connected with the tuned mass for hanging the tuned mass; and the reverse helical compression springs are used to balance the gravity of the tuned mass and provide stiffness for a vibrating system, and the two form the low-frequency tuned mass damping device. The helical compression springs have large original length and small stiffness, and occupy a small space after reverse stretching, but can already bear a large weight of the tuned mass and maintain low stiffness that remains basically unchanged. Therefore, low-frequency tuning can be achieved. Since the helical compression springs change from an initial compression state to an operating tension state, the instability problem faced by the compression springs is not involved, and lateral connections do not need to be added. Therefore, the damping is very low. In addition, a damping element with appropriate parameters is arranged as required to provide additional damping for the low-frequency tuned mass damping device, achieving the optimal control effect.

The helical compression springs are not limited in material, size and cross-sectional form and are reversely stretched to facilitate supercompression deformation, and the spring index should be as large as possible (e.g., ≥20). The helical compression springs are made into conical (tower-shaped) springs with a gradually changing outer diameter. The taper is not limited and is designed according to the requirements. A taper of zero means a traditional equal-diameter spring. The larger the taper, the easier it is to perform supercompression and reverse stretching. However, the taper should not be too large; otherwise, the strength and stiffness of adjacent coils of the spring will vary greatly, and the force will be unreasonable. Helical compression springs that are too long may not be convenient for supercompression and reverse stretching, and thus can be flipped in sections and finally connected in series. The helical compression springs can also be symmetrically arranged on both sides of a torsional vibration structure to control low-frequency torsional vibration. When the helical compression springs are used as horizontal springs for low-frequency vibration control and the horizontal space is limited, the same treatment method as above can also be applied to the horizontal helical compression springs for supercompression and reverse stretching to achieve low-frequency tuning. The helical compression springs are arranged vertically, horizontally or obliquely.

The specific material and structural form of the tuned mass are not limited. Compared with tuned masses (usually steel plates with a higher density) used in traditional tuned mass dampers, the spatial restrictions are more lenient. Therefore, concrete blocks or water tanks with a lower density and a cost that can be one or even two orders of magnitude lower can be adopted.

The damping element is used to adjust the damping of the low-frequency tuned mass damping device, so that the system damping reaches an ideal target value and ensures the effect of vibration control, and the form thereof is not limited.

The present invention has the following beneficial effects: (1) when the initial force state of the compression spring is changed from compression to tension, the axial stiffness remains basically unchanged, and greater deformation can be achieved within the same vertical space, thus achieving a lower frequency than traditional compression springs; (2) the traditional compression springs are always under compression in the working state and have a stability problem, while the springs of the present invention are always under tension in the final working state and have no stability problem; (3) the present invention does not require the addition of multiple layers of transverse stabilizing plates or vertical guide rods, and has simple structure, low damping and good stability, ensuring the efficiency of vibration control; (4) a lower tuning frequency can be achieved within a limited vertical space, greatly expanding the frequency application range of the tuned mass device; (5) the springs of the present invention can be arranged vertically, horizontally, obliquely or as required, have a free form, and can be applied to the control of various types of low-frequency vibration in vertical, lateral and torsional directions of various engineering structures, with a wide range of applicable scenarios.

### DESCRIPTION OF DRAWINGS

FIG. 1 is a structural diagram of a low-frequency tuned mass damping device with reverse-stretched compression springs, which is installed in a main beam of a bridge;

FIG. 2 is a schematic diagram of a supercompression-reverse stretching deformation process of a regular conical spring;

FIG. 3 is a schematic diagram of a supercompression-reverse stretching deformation process of an inverted conical spring;

In the figures: 1 helical compression spring; 2 tuned mass; 3 damping element. \textcircled{1}, \textcircled{i} and \textcircled{N} are respectively three signs of an uppermost coil, a certain middle coil and a lowermost coil of the conical spring, which are used to visually illustrate the supercompression-reverse stretching deformation process of the helical compression spring.

### DETAILED DESCRIPTION

Specific embodiments of the present invention are described below in detail in combination with the technical solution and the drawings.

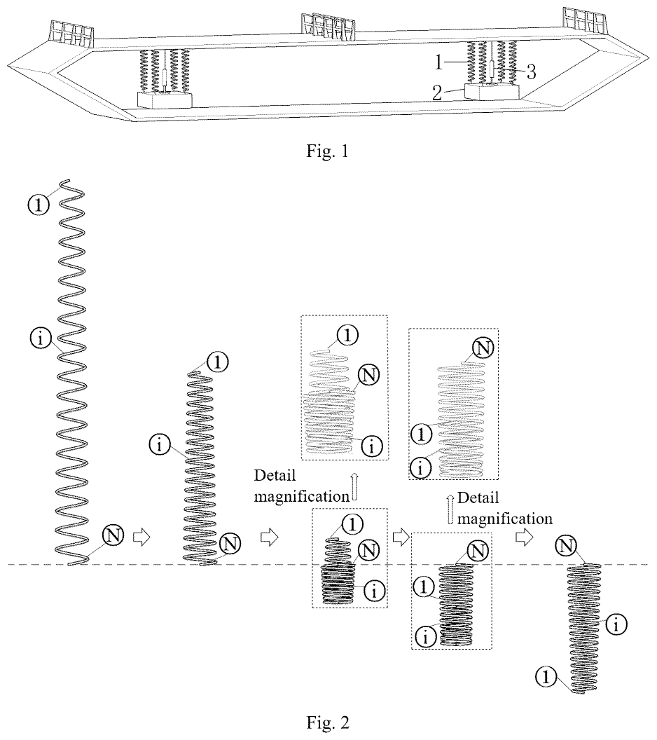

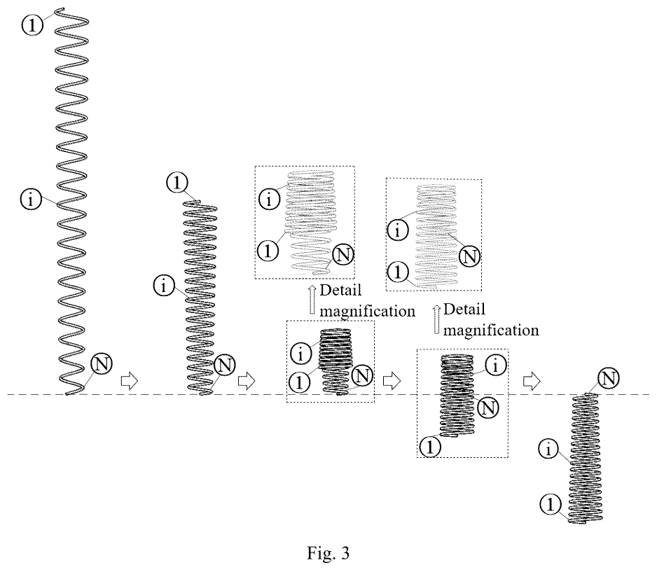

As shown in FIG. 1, a low-frequency tuned mass damping device with reverse-stretched compression springs, comprising helical compression springs 1, a tuned mass 2 and a damping element 3. Specific embodiments are described below with two typical cases of vertical placement of the springs as examples. Specific steps are as follows:
placing the helical compression springs 1 vertically and fixing the bottom coils on circular rings having appropriate sizes. For the case shown in FIG. 2, applying axial pressure to the top coils to fully compress the springs until the springs, except the lowermost coils, pass through the bottom coils from the middle to complete flipping. For the case shown in FIG. 3, applying axial pressure to the tops of the helical compression springs 1 to fully compress the springs until the springs, except the lowermost coils, fit over the bottom coils from the outside to complete flipping. For the above two types of typical springs, after completing flipping, fixing the springs in the flipped state, with the specific fixing method not limited. Then, installing the bottom coils of the helical compression springs 1 in the flipped and stretched state on a top plate of a box girder or at the top of a built-in support of the box girder, with the specific fixing method not limited. The initial top coils of the hung helical compression springs 1 (that can be called reverse helical compression springs 1 at this time) are located at lowermost expansion ends and are connected with the tuned mass 2 for hanging the tuned mass 2. The reverse helical compression springs 1 are used to balance the gravity of the tuned mass 2 and provide stiffness for a vibrating system, and the two form the tuned mass device. The helical compression springs 1 have large original length and small stiffness, and occupy a small space after reverse stretching, but can already bear a large weight of the tuned mass 2, fully achieve large compression deformation and reverse stretching deformation of the springs within the limited space and maintain low stiffness that remains basically unchanged. Therefore, low-frequency tuning can be achieved. Since the helical compression springs 1 change from an initial compression state to an operating tension state, the instability problem faced by the traditional compression springs is not involved, and lateral connections do not need to be added. Therefore, the damping is very low. A damping element 3 with appropriate parameters can be arranged at an appropriate position as required to provide additional damping for the tuned mass damping device, achieving the optimal control effect.

The above only describes preferred embodiments of the present invention and is not intended to limit the present invention in any form. Any equivalent change, modification or evolution made to the above embodiments by those skilled in the art through the technical solutions of the present invention shall still belong to the scope of the technical solutions of the present invention.

1. A low-frequency tuned mass damping device with reverse-stretched compression springs, wherein the low-frequency tuned mass damping device comprises helical compression springs (1) and a tuned mass (2);
the helical compression springs (1) are placed vertically, horizontally or obliquely, the bottom coils are fixed on circular rings having corresponding sizes, pressure is continuously applied to the helical compression springs (1) at the top coils or intermediate local positions of the helical compression springs (1) until the top coils of the helical compression springs (1) pass through or fit over the bottom coils and flip over, and the helical compression springs (1) are fixed in the flipped state; the bottom coils of the helical compression springs (1) in the flipped states are installed on a top plate of a box girder or at the top of a built-in support of the box girder, and the helical compression springs (1) at this time are reverse helical compression springs (1); the top coils of the helical compression springs (1) are located at lowermost expansion ends and are connected with the tuned mass (2) for hanging the tuned mass (2); and the reverse helical compression springs (1) are used to balance the gravity of the tuned mass (2) and provide stiffness, and the two form the low-frequency tuned mass damping device.

2. The low-frequency tuned mass damping device according to claim 1, further comprising a damping element (3) which provides required damping for the low-frequency tuned mass damping device.

3. The low-frequency tuned mass damping device according to claim 1, wherein the helical compression springs (1) are made into gradually changing conical or tower-shaped springs.
